(19) United States
(12) Patent Application Publication
(10) Pub. No.: US 2019/0126416 A1
(43) Pub. Date: May 2, 2019

(54) CLAMPING DEVICE FOR AN ENGINE PARTS GRINDER, AND ITS THREE-POINT CLAMPING STRUCTURE AND PIVOTING CONTROL STRUCTURE

(71) Applicant: YON-FONG MACHINERY CO., LTD, CHANGHUA COUNTY (TW)

(72) Inventor: Feng-Yu Chang, CHANGHUA COUNTY (TW)

(21) Appl. No.: 15/801,323

(22) Filed: Nov. 2, 2017

(51) Int. Cl. B23Q 3/06; B24B 7/16

(52) U.S. Cl. CPC B23Q 3/062; B24B 7/16

(57) ABSTRACT

A clamping device for an engine parts grinder, and its three-point clamping structure and pivoting control structure. With the three-point clamping structure and the pivoting control structure, the clamping device is capable of clamping the workpiece in a three point clamping manner with a stable clamping force. The pivoting control structure moves in pivoting motion to control the operating member to make the clamping member move downward or upward to clamp or to release the workpiece, and therefore the operation is very simple. Meanwhile, the operating member and the pressing unit provide a one-way self-locking function, and the elastic abutting unit presses against the cam portion of the pressing unit to create a position restricting effect. In addition to providing a stable clamping force, the operating member can be automatically locked when pivoted to a positioning position, which makes the clamping device very convenient to use.

### BACKGROUND

### Field of the Invention

The present invention relates to a clamping device, and more particularly to a clamping device for an engine parts grinder, and its three-point clamping structure and pivoting control structure.

### Related Prior Art

The engine is a power source of a vehicle. For a four stroke engine, it mainly operates by primarily sucking the mixed gas containing fuel and air into the cylinder, then the piston is moved by the crank to compress the gas into a mixed gas of high temperature and pressure, and then the mixed gas is ignited by the ignition plug and explodes in a flash to push the piston to perform reciprocating linear motion in the cylinder to generate power. Finally, the exhaust gas after combustion is discharged from the cylinder, and by such continuous cycle of operation, power can be produced to drive the vehicle to move.

It can be learned from the above that the engine consists of many parts, and the sucking and discharging of gas cannot be performed without a valve structure. The valve structure includes a valve stein and a conical valve head formed at one end of the valve stein. Generally, there is almost no clamping device for stably clamping the valve structure during the manufacturing or grinding process, therefore, the precision of the finished products of the valve structure still needs to be improved. If a three jaw chuck is used for clamping the valve structure, a rotation drive hand tool must be used to rotate the three jaw chuck to perform clamping or releasing of the valve structure. In addition to the inconvenience caused by the use of the rotation drive hand tool, the amount of displacement of the chuck caused by a full circle of rotation of the rotation drive hand tool is very small. Hence, the action of controlling the clamping and releasing operation of the chuck is very time consuming and laborious.

The present invention has arisen to mitigate and/or obviate the afore-described disadvantages.

### SUMMARY

One objective of the present invention is to provide a clamping device for an engine parts grinder, and its three-point clamping structure and pivoting control structure, capable of solving abovementioned problem that there is almost no clamping device for stably clamping the valve structure during the manufacturing or grinding process, therefore, the precision of the finished products still needs to be improved.

Another objective of the present invention is to provide a clamping device for an engine parts grinder, which is capable of micro-adjusting the clamping force of the clamping device to meet different requirements.

To achieve the above objectives, a clamping device for an engine parts grinder in accordance with the present invention, comprises:

a drive source including a drive toothed wheel sleeved onto and driven by a drive shaft, and two driven toothed wheels engaged with the drive toothed wheel;

a base including an assembling shaft portion extending in an axial direction, and an assembling hole extending in the axial direction, wherein a direction perpendicular to the axial direction is defined as a radial direction, the base is connected to the drive source;

a three-point clamping structure including a first support member, a second support member and a clamping member, wherein the first support member includes a first shaft and a first abutting wheel located at one end of the first shaft, the first shaft is pivotally inserted through the base and fixed to one of the driven toothed wheels, in such a manner that the first abutting wheel protrudes out of the base, the second support member includes a second shaft and a second abutting wheel located at one end of the second shaft, the second shaft is pivotally inserted through the base and fixed to another one of the driven toothed wheels, in such a manner that the second abutting wheel protrudes out of the base, the clamping member is mounted on a pivoting control structure pivotally mounted on the base, and is able to pivot toward or away from the first and second support members;

the pivoting control structure is mounted on the base to pivotally press a workpiece, and includes an operating member, an elastic abutting unit and a pressing unit, wherein the operating member includes an operating handle pivotally mounted on the assembling shaft portion of the base, and includes a helical groove formed in an outer peripheral surface of the operating member;

the elastic abutting unit sequentially includes a sealing cover, a spring and an abutting head, the sealing cover serves to seal one end of the assembling hole, the spring serves to press the abutting head, and the abutting head partially protrudes out of another end of the assembling hole; and

the pressing unit includes a driven shaft portion, and a cam arm and an extension arm formed at two sides of the driven shaft portion, respectively, the driven shaft portion includes a driven protrusion, the cam arm includes a cam portion, and the extension arm is pivotally connected to the clamping member, the cam portion of the pressing unit is pivotally connected to the base by a pivot extending in the radial direction, in such a manner that the cam portion abuts against the abutting head, the driven protrusion is received in the helical groove, the helical groove and the driven protrusion provide a self-locking function, so that the operating member is able to drive the driven protrusion to move, while the driven protrusion is unable to drive the operating member to move, the pressing unit is moved by the operating member to make the clamping member pivot toward the first and second support members disposed on the base to clamp the workpiece.

To achieve the above objective, the present invention further provides a three-point clamping structure for a clamping device for an engine parts grinder, which is used in combination with a drive source and a base to stably clamp a workpiece and drive the workpiece to rotate. The drive source including a drive toothed wheel sleeved onto and driven by a drive shaft, and two driven toothed wheels engaged with the drive toothed wheel. The base is connected to the drive source. The three-point structure comprises:

a first support member pivotally mounted on the base and has one end inserted through the base and fixed to one of the driven toothed wheels;

a second support member pivotally mounted on the base and has one end inserted through the base and fixed to another one of the driven toothed wheels; and

a clamping member is mounted on a pivoting control structure pivotally mounted on the base, and therefore is able to pivot toward or away from the first and second support members.

To achieve the above objective, the present invention further provides a pivoting control structure which is mounted on the base to pivotally press a workpiece, the base includes an assembling hole extending in the axial direction, a direction perpendicular to the axial direction is defined as a radial direction. The pivoting control structure includes an operating member, an elastic abutting unit and a pressing unit.

The operating member includes an operating handle and is pivotally mounted on the assembling shaft portion of the base, and a helical groove is formed in an outer peripheral surface of the operating member.

The elastic abutting unit sequentially includes a sealing cover, a spring and an abutting head, the sealing cover serves to seal one end of the assembling hole, the spring serves to press the abutting head, and the abutting head partially protrudes out of another end of the assembling hole.

The pressing unit includes a driven shaft portion, and a cam arm and an extension arm formed at two sides of the driven shaft portion, respectively, the driven shaft portion includes a driven protrusion, the cam arm includes a cam portion, and the extension arm is pivotally connected to the clamping member, the cam portion of the pressing unit is pivotally connected to the base by a pivot extending in the radial direction, in such a manner that the cam portion abuts against the abutting head, the driven protrusion is received in the helical groove, the helical groove and the driven protrusion provide a self-locking function, so that the operating member is able to drive the driven protrusion to move, while the driven protrusion is unable to drive the operating member to move, the pressing unit is moved by the operating member to make the clamping member clamp the workpiece.

Preferably, the extension arm includes a stationary seat and a retractable seat, the stationary seat includes a through hole for insertion of the retractable seat, the clamping member is pivotally connected to one end of the retractable seat, a length of the retractable seat is adjustable, when the length of the retractable seat is increased, a clamping force of the clamping member applied to the workpiece also increases, and conversely, when the length of the retractable seat decreases, the clamping force applied to the workpiece by the clamping member also decreases.

With the three-point clamping structure and the pivoting control structure, the clamping device for an engine parts grinder of the invention is capable of clamping the workpiece in a three point clamping manner to provide a stable clamping force. The pivoting control structure provides a pivoting motion to control the operating member to make the clamping member move downward or upward to clamp or to release the workpiece, and therefore the operation is very simple. Meanwhile, the operating member of the pivoting control structure and the pressing unit provide a one-way self-locking function, and the elastic abutting unit presses against the cam portion of the pressing unit to create a position restricting effect. In addition to providing a stable clamping force, the operating member can be automatically locked when pivoted to a positioning position, which makes the clamping device very convenient to use.

Besides, rotating the pivoting member can control the displacement of the movable member, which consequently controls the length of the retractable seat, and then with the aid of the elastic abutting unit, the clamping force for clamping the workpiece applied by the clamping member can be micro-adjusted.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is an exploded view of the clamping device for an engine parts grinder in accordance with a preferred embodiment of the invention;

FIG. 2 is an assembly view of the clamping device for an engine parts grinder in accordance with the preferred embodiment of the invention;

FIG. 3 is an illustrative view of a three-point clamping structure of the clamping device for an engine parts grinder in accordance with the preferred embodiment of the invention;

FIG. 4 is a cross sectional of a part of the clamping device for an engine parts grinder in accordance with the preferred embodiment of the invention, wherein the clamping member is located at the highest position;

FIG. 5 is in illustrative view of the clamping device for an engine parts grinder in accordance with the preferred embodiment of the invention, showing the action of turning the operating member;

FIG. 6 is an assembly view of the clamping device for an engine parts grinder in accordance with the preferred embodiment of the invention, wherein the clamping member is at the lower position;

FIG. 7 is a plan view of FIG. 6;

FIG. 8 is an exploded view of the extension arm of the clamping device for an engine parts grinder in accordance with another preferred embodiment of the invention;

FIG. 9 is a cross sectional view of the extension arm of the clamping device for an engine parts grinder in accordance with another preferred embodiment of the invention;

FIG. 10 is a cross sectional view of the extension arm of the clamping device for an engine parts grinder in accordance with another preferred embodiment of the invention;

FIG. 11 is a cross sectional view of the elastic abutting unit of the clamping device for an engine parts grinder in accordance with another preferred embodiment of the invention;

FIG. 12 is a cross sectional view of the elastic abutting unit of the clamping device for an engine parts grinder in accordance with another preferred embodiment of the invention; and

FIG. 13 is an assembly view of the clamping device for an engine parts grinder in accordance with another preferred embodiment of the invention.

### DETAILED DESCRIPTION

The present invention will be clearer from the following description when viewed together with the accompanying drawings, which show, for purpose of illustrations only, the preferred embodiment in accordance with the present invention.

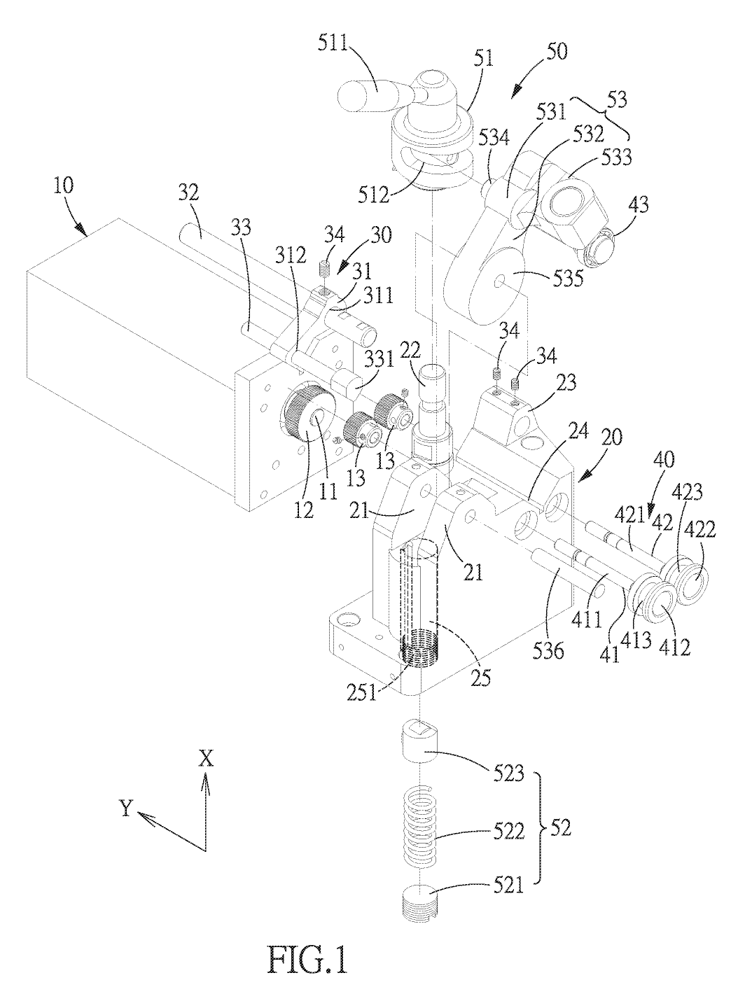

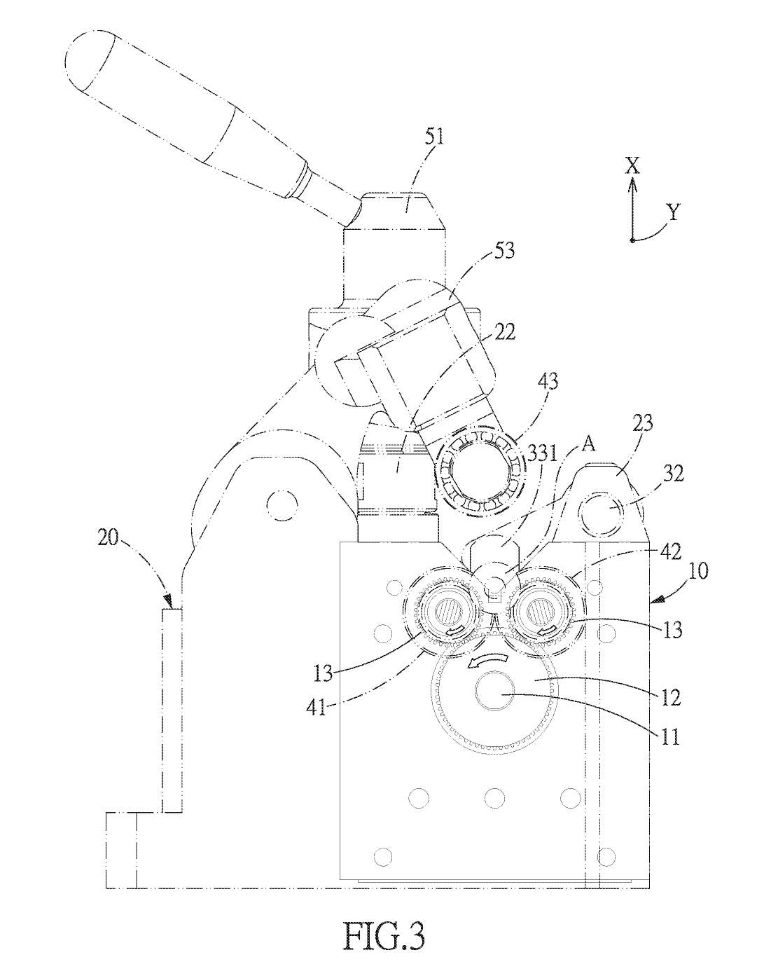

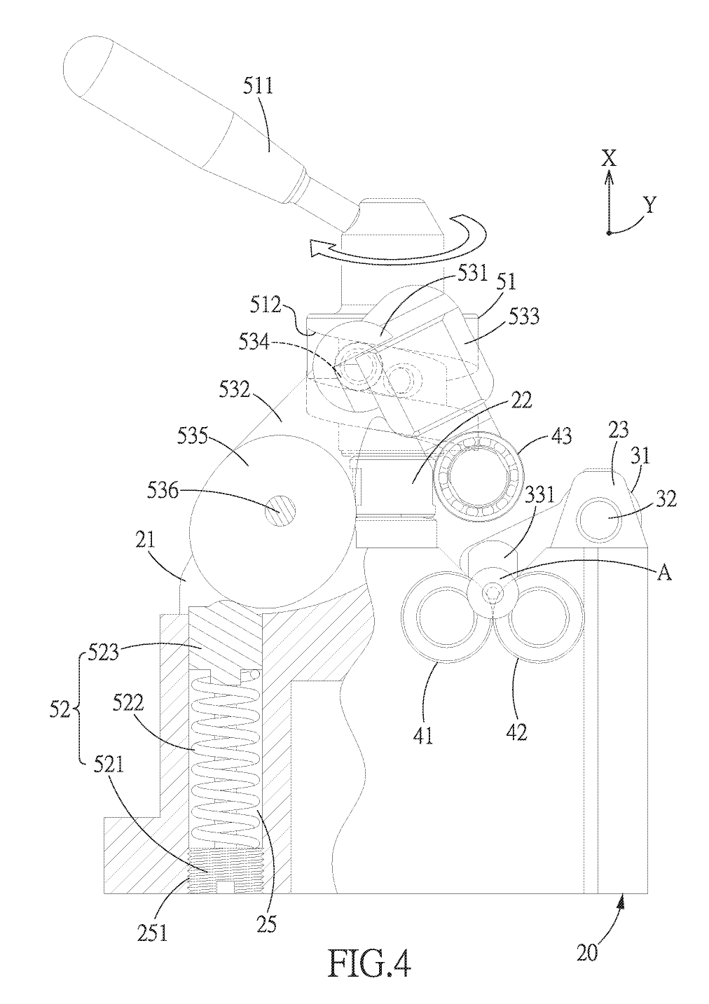

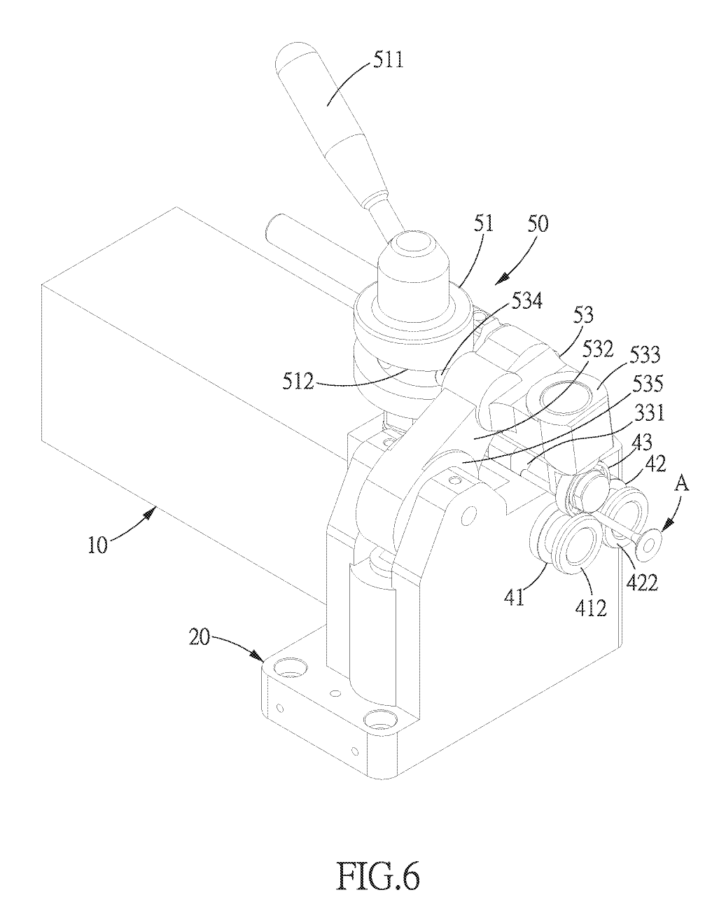

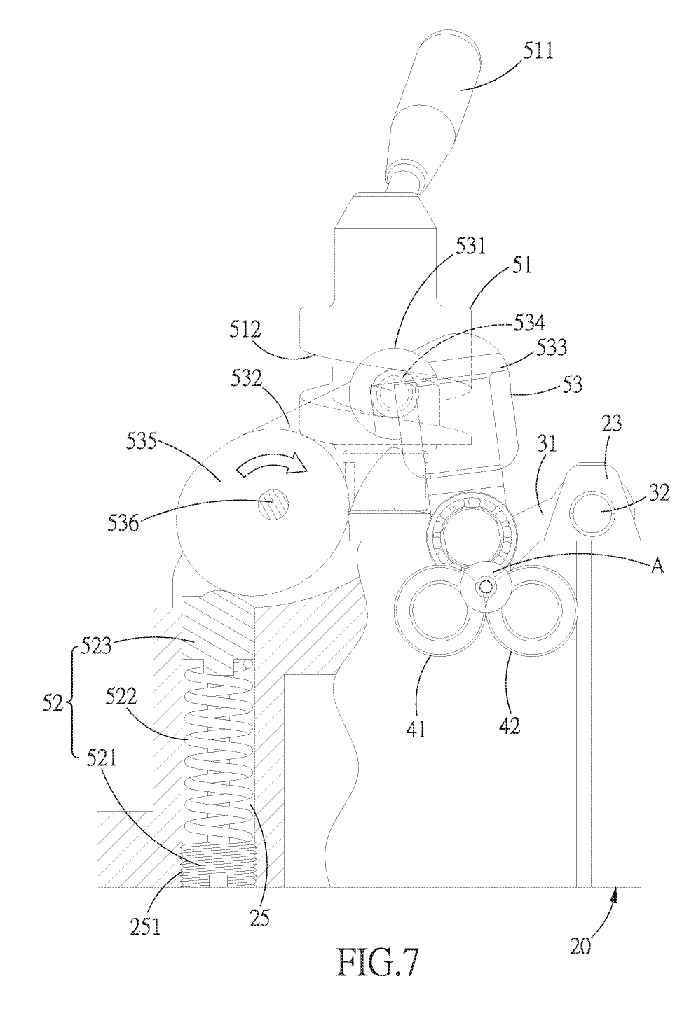

Referring to FIGS. 1-7, a clamping device for an engine parts grinder in accordance with the preferred embodiment of the invention comprises: a drive source 10, a base 20, a three-point clamping structure 40 and a pivoting control structure 50.

The drive source 10 includes a drive toothed wheel 12 sleeved onto and driven by a drive shaft 11, and two driven toothed wheels 13 engaged with the drive toothed wheel 12.

The base 20 includes two opposite assembling portions 21, an assembling shaft portion 22 extending in an axial direction X, an insertion portion 23, a guide groove 24 and an assembling hole 25 extending in the axial direction X. The guide groove extends in a radial direction Y perpendicular to the axial direction X, the assembling hole 25 includes a threaded section 251, and the base 20 is connected to the drive source 10 via an adjustment structure 30.

The adjustment structure 30 includes an inserting member 31, a slide rod 32 and a stationary rod 33. The inserting member 31 is fixed to the drive source 10 and includes a first insertion hole 311 and a second insertion hole 312. The slide rod 32 is slidably inserted in the first insertion hole 311 and received in the insertion portion 23 of the base 20. A plurality of screws 34 are screwed through the inserting member 31 and the insertion portion 23 to fix the slide rod 32 to the inserting member 31 and the insertion portion 23. The stationary rod 33 is inserted and fixed in the second insertion hole 312 and provided at one end thereof with an abutting portion 331 to be abutted against the guide groove 24 of the base 20.

The three-point clamping structure 40 includes a first support member 41, a second support member 42 and a clamping member 43. The first support member 41 and the second support member 42 are pivotally mounted on the base 20. In this embodiment, the first support member 41 includes a first shaft 411 and a first abutting wheel 412 located at one end of the first shaft 411. The first shaft 411 is pivotally inserted through the base 20 and fixed to one of the driven toothed wheels 13 of the drive source 10, in such a manner that the first abutting wheel 412 protrudes out of the base 20. The second support member 42 includes a second shaft 421 and a second abutting wheel 422 located at one end of the second shaft 421. The second shaft 421 is pivotally inserted through the base 20 and fixed to another one of the driven toothed wheels 13, in such a manner that the second abutting wheel 422 protrudes out of the base 20. Meanwhile, the first and second abutting wheels 412, 422 are located at two sides of the guide groove 24, and each include an avoiding groove 413, 423 along a peripheral surface thereof. The clamping member 43 is mounted on the pivoting control structure 50 pivotally mounted on the base 20, and therefore is able to pivot toward or away from the first and second support members 41, 42. The clamping member 43 has a thickness smaller than a width of the avoiding groove 413, 423 of the first and second abutting wheels 412, 422.

The pivoting control structure 50 includes an operating member 51, an elastic abutting unit 52 and a pressing unit 53.

The operating member 51 includes an operating handle 511 pivotally mounted on the assembling shaft portion 22 of the base 20, and includes a helical groove 512 formed in an outer peripheral surface of the operating member 51.

The elastic abutting unit 52 sequentially includes a sealing cover 521, a spring 522 and an abutting head 523. The sealing cover 521 is screwed in the threaded section 251 to seal one end of the assembling hole 25. The spring 522 is located between the sealing cover 521 and the abutting head 523 to press the abutting head 523 which protrudes out of another end of the assembling hole 25.

The pressing unit 53 includes a driven shaft portion 531, and a cam arm 532 and an extension arm 533 formed at two sides of the driven shaft portion 531, respectively. The driven shaft portion 531 includes a driven protrusion 534, the cam arm 532 includes a cam portion 535, and the extension arm 533 is pivotally connected to the clamping member 43. The cam portion 535 of the pressing unit 53 is pivotally connected between the two assembling portions 21 of the base 20 by a pivot 536 extending in the radial direction Y, in such a manner that the cam portion 535 abuts against the abutting head 523 of the elastic abutting unit 52, and the driven protrusion 534 of the pressing unit 53 is received in the helical groove 512 of the operating member 51. In this embodiment, the helical groove 512 and the driven protrusion 534 provide a self-locking function, namely, the operating member 51 is able to drive the driven protrusion 534 to move, while the driven protrusion 534 is unable to drive the operating member 51 to move. The pressing unit 53 is moved by the operating member 51 to make the clamping member 43 pivot toward the first and second support members 41, 42 disposed on the base 20 to clamp a workpiece A.

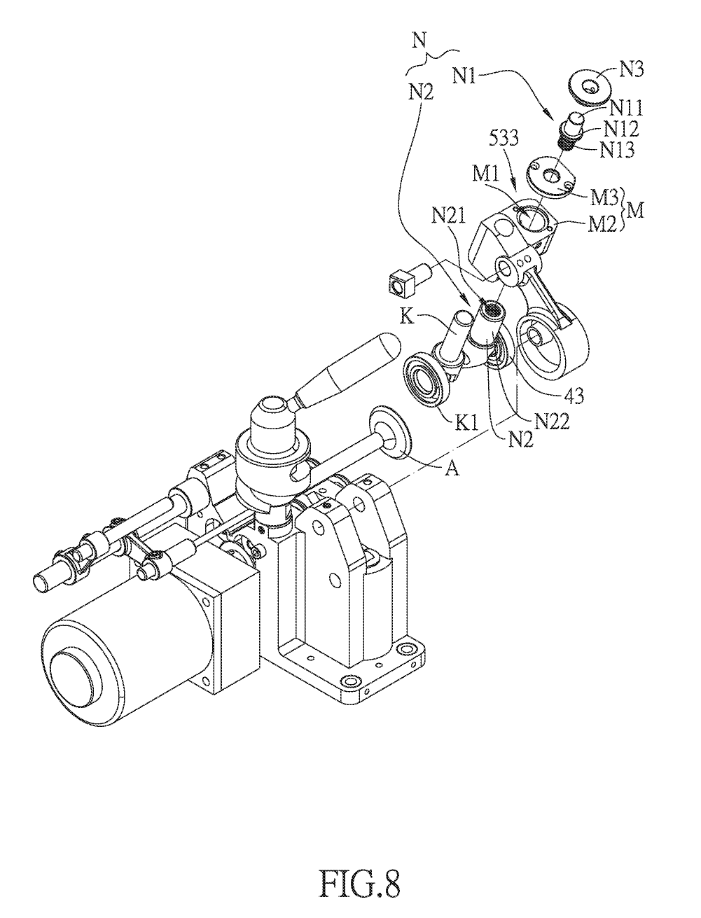

In another preferred embodiment of the present invention as shown in FIGS. 8-10, the extension arm 533 includes a stationary seat M and a retractable seat N. The stationary seat M includes a through hole M1 for insertion of the retractable seat N. The clamping member 43 is pivotally connected to one end of the retractable seat N. The length of the retractable seat N is adjustable to allow the clamping member 43 to have different clamping force. When the length of the retractable seat N is increased, the clamping force of the clamping member 43 applied to the workpiece A also increases, and conversely, when the length of the retractable seat N decreases, the clamping force applied to the workpiece A by the clamping member 43 also decreases.

More specifically, the stationary seat M includes a seat body M2 and a seat cover M3 which covers one end of the seat body M2. The retractable seat N includes a pivoting member N1 and a movable member N2. A direction in which the retractable seat N extends is defined as a retracting direction Z. The pivoting member N1 is sequentially provided in the retracting direction Z with a pivoting section N11, a restricting section N12 and a threaded section N13. The restricting section N12 has a diameter larger than a diameter of the pivoting section N11 and a diameter of the threaded section N13. The restricting section N12 and the threaded section N13 are inserted in the through hole M1, in such a manner that the restricting section N12 is abutted against the seat cover M3 to act as a travel limiter. The threaded section N13 is provided on an outer surface thereof with a thread, and the pivoting section N11 protrudes out of the stationary seat M and is to be rotated by the user.

The clamping member 43 is pivotally connected to one end of the movable member N2 which is inserted in the through hole M1, and another end of the movable member N2 is formed with a threaded hole N21 in which the threaded section N13 is to be screwed, so that, when the user rotates the pivoting member N1 with respect to the stationary seat M, the movable member N2 will move along the retracting direction Z, and thus the length of the retractable seat N can be adjusted.

A rotating handle N3 is sleeved onto the pivoting section N11 and has one end abutted against the seat cover M3, which prevents the pivoting member N1 from moving in the retracting direction Z, and makes it easier for the user to grip and to do length adjustment.

The movable member N2 includes an outer surface N22, and an adjustment groove N23 formed in the outer surface N22 and extending in the retracting direction Z. The seat body M2 is provided with a penetrating hole M21, and a bolt is inserted in the penetrating hole M21 and pressed against the adjustment groove N23 to act as a fixing means after length adjustment.

The extension arm 533 is preferably provided with an assistant seat K which is to be pivotally connected to the stationary seat M. The assistant seat K is parallel to and can be driven to move together with the retractable seat N along the retracting direction Z. An assistant abutting member K1 is provided at one end of the assistant seat K to press against the workpiece A.

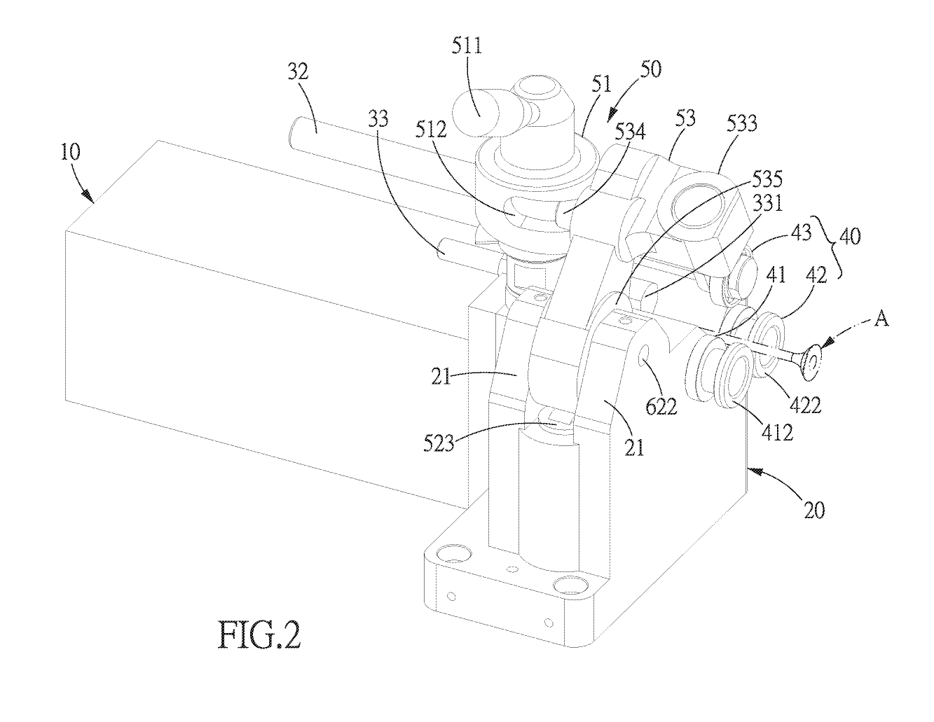

What mentioned above are the structural relations of the clamping device for an engine parts grinder in accordance with the preferred embodiment of the invention, and the clamping device is particularly suitable for clamping the workpiece A, such as the valve. For example, when the clamping device does not clamp the workpiece A, as shown in FIGS. 2-4, the driven protrusion 534 of the pressing unit 53 is located at a relatively high position within the helical groove 512 with respect to the axial direction X. In this condition, the clamping member 43 mounted on the extension arm 533 of the pressing unit 53 is in a position farther away from the first and second support members 41, 42, so that the workpiece A can be taken out of or put into the clamping device. When put into the clamping device, the workpiece A is placed between the first abutting wheel 412 of the first support member 41 and the second abutting wheel 422 of the second support member 42, and has one end abutted against the abutting portion 331.

To work in with the grinding position of the grinder on the workpiece A, when the workpiece A is inserted in the clamping device, the position of the stationary rod 33 can be adjusted to adjust the position of the workpiece A along the radial direction Y. The position of the stationary rod 33 can be easily adjusted by releasing the screws 34 for fixing the inserting member 31 and the slide rod 32 to allow the inserting member 31 to move along the slide rod 32. When the position of the inserting member 31 is changed, the positions of the drive source 10 and the stationary rod 33 will also change with the inserting member 31. Once the position of the stationary rod 33 changes, the position of the abutting portion 331 of the stationary rod 33 in the guide groove 24 will be changed, and so will be the position of the workpiece A in the radial direction Y.

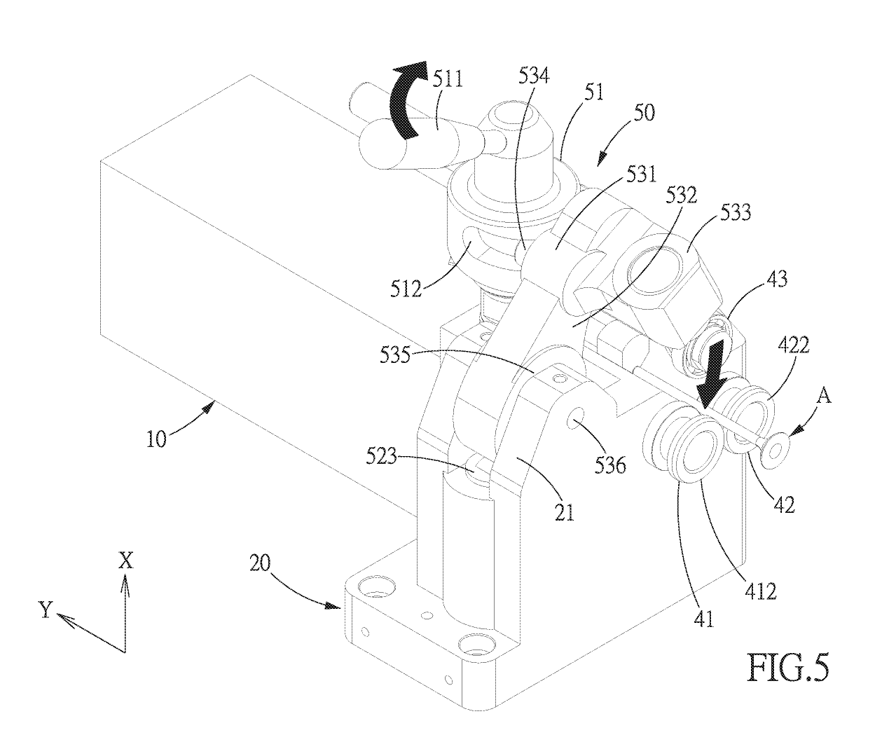

When the workpiece A is placed between the first and second support members 41, 42, as shown in FIG. 5, turning the operating handle 511 can rotate the operating member 51 and can change the position of the driven protrusion 534 of the driven shaft portion 531 in the helical groove 512, for example, as shown in FIGS. 5-7, the driven protrusion 534 is adjusted to the relatively lower position within the helical groove 512 along the axial direction X.

Meanwhile, when the position of the driven shaft portion 531 of the pressing unit 53 is changing, the cam portion 535 of the cam arm 532 will pivot around the pivot 536 to continuously press the abutting head 523 of the elastic abutting unit 52. At the same time, the extension arm 533 is also moved to a relatively lower position. Continuously pivoting the pressing unit 53 can make the clamping member 43 mounted on the extension arm 533 gradually move close to the first and second support members 41, 42 until the clamping member 43 moves into the avoiding groove 413, 423 of the first and second support members 41, 42 and presses against the workpiece A disposed between the first and second support members 41, 42. The clamping of the workpiece A is completed when the clamping member 43 presses against the workpiece A. besides, when the pressing unit 53 of this embodiment drives the clamping member 43 to pivot to the lower position, the clamping member 43 is located between the first and second abutting wheels 412, 422 to create a stable three-point clamping with the first and second abutting wheels 412, 422.

Moreover, since the angle of the helical groove 512 provides a self-locking function, self-locking will be formed when the operating member 51 is pivoted to the positioning position, and the positioning and locking action can be achieved without the use of any locking component. Meanwhile, the abutting head 523 of the elastic abutting unit 52 is pushed by the spring 522 to press against the cam portion 535 of the pressing unit 53, therefore, the cam portion 535 of the abutting head 523 also provides a restricting force to prevent the position of the pressing unit 53 from being easily changed when the operating member 51 is not moved, thus increasing the clamping force.

When the workpiece A is assuredly clamped during grinding or polishing operation, and the drive shaft 11 of the drive source 10 is rotated to rotate the drive toothed wheel 12, due to the fact that the driven toothed wheels 13 are engaged with the same drive toothed wheel 12, the respective driven toothed wheels 13 will be driven to rotate in the same direction, consequently rotate the workpiece A to perform grinding or polishing operation.

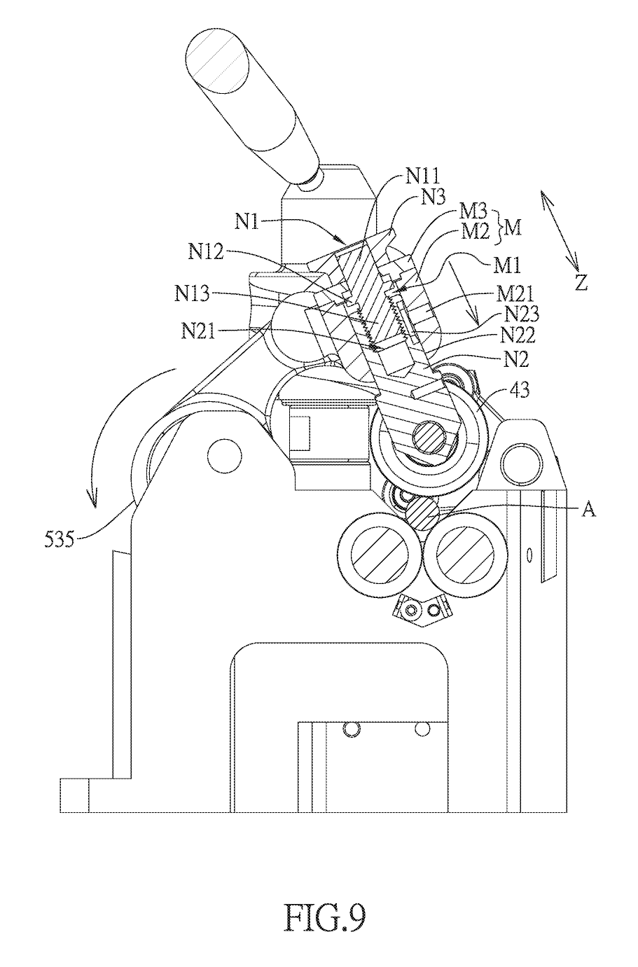

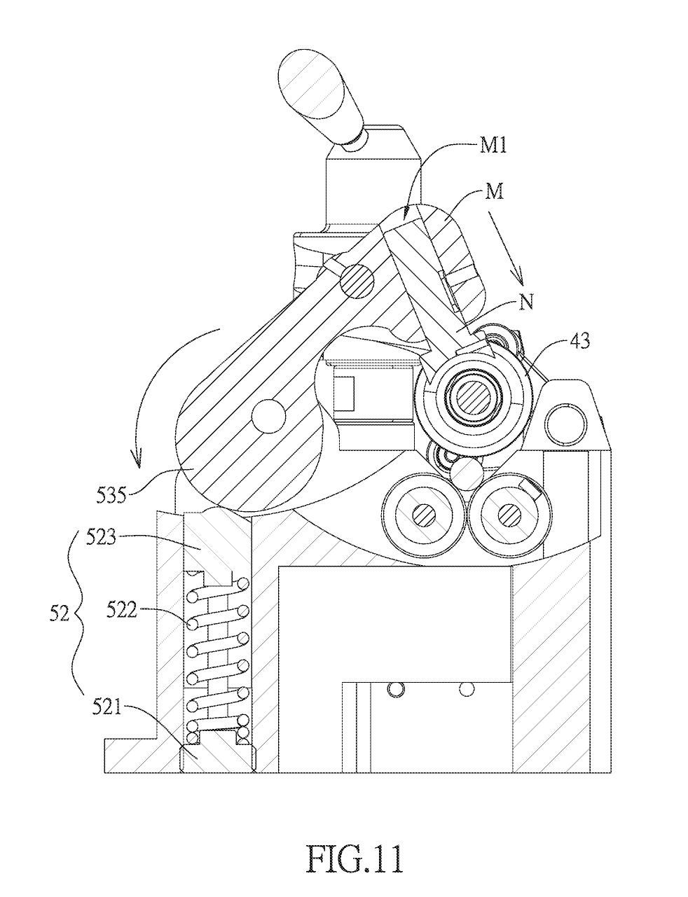

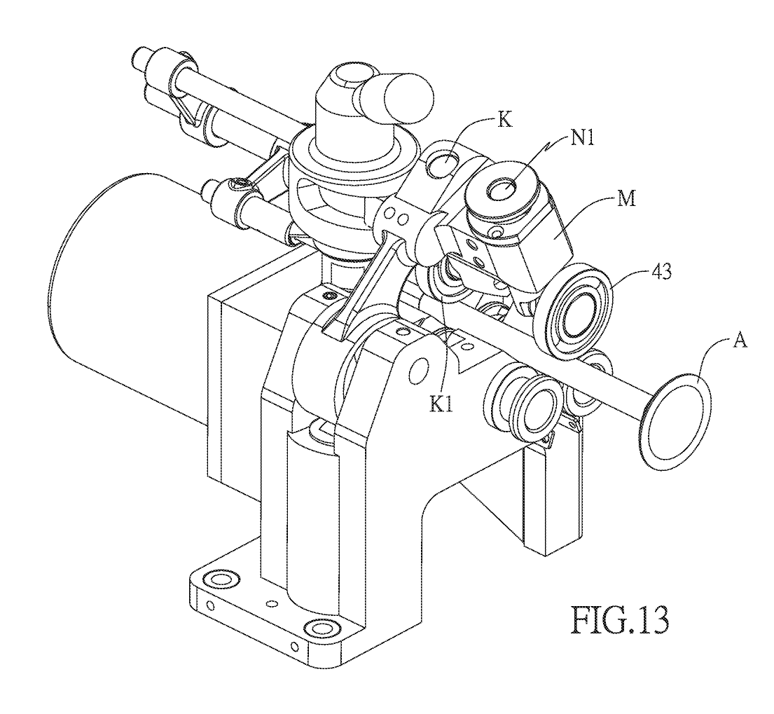

Referring then to FIGS. 8-13, rotating the rotating handle N3 can rotate the pivoting section N11, which consequently drives the threaded section N13 to rotate, and finally the movable member N2 is driven to move along the retracting direction Z. As shown in FIGS. 9 and 11, since the elastic abutting unit 52 is abutted against the cam portion 535 to make the clamping member 43 to press against the workpiece A, so that, when the movable member N2 moves toward the workpiece A, the length of the retractable seat N in the retracting direction Z increases, and the cam portion 535 will pivot to press the elastic abutting unit 52, thus increasing the compression force of the spring 522, consequently increasing the clamping force applied to the workpiece A by the clamping member 43.

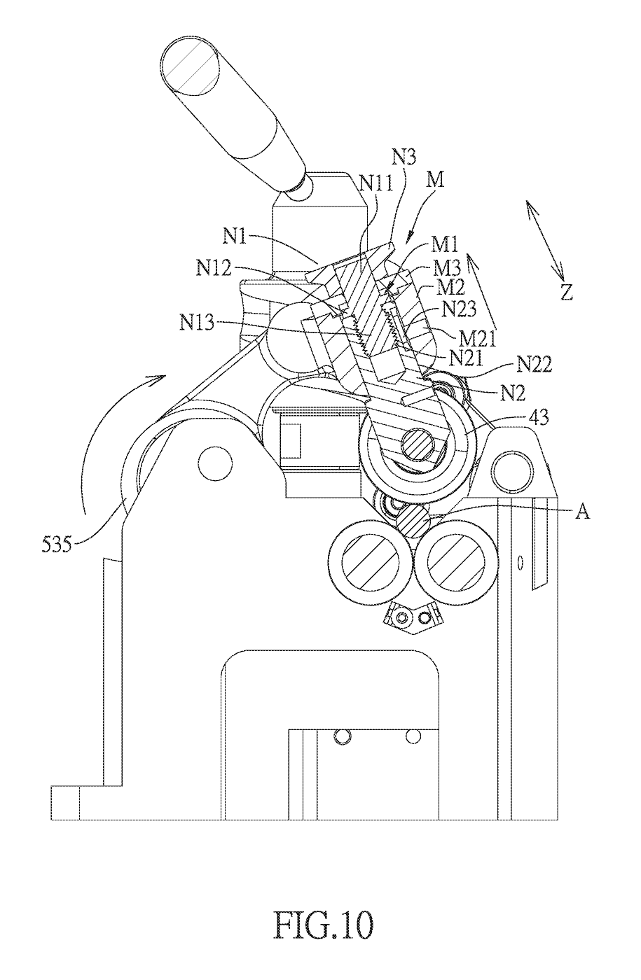

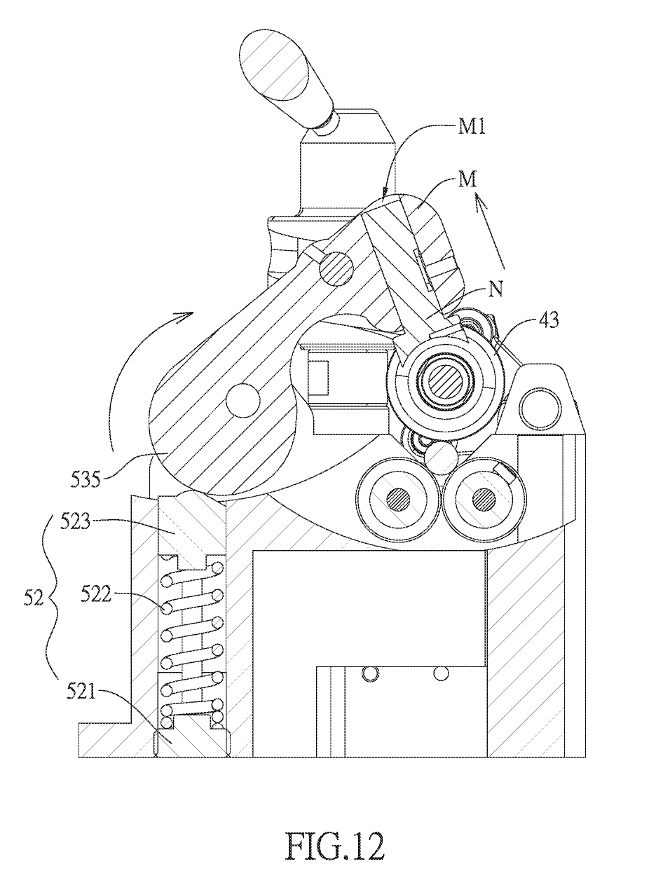

Conversely, since the elastic abutting unit 52 is abutted against the cam portion 535 to make the clamping member 43 to press against the workpiece A, when the movable member N2 moves away from the workpiece A, as shown in FIGS. 10 and 12, the length of the retractable seat N in the retracting direction Z decreases, and the cam portion 535 will pivot to release the elastic abutting unit 52, as a result, the compression force of the spring 522 is reduced, consequently decreasing the clamping force applied to the workpiece A by the clamping member 43.

To sum up, the three-point clamping structure 40 of the invention is capable of firmly clamping the workpiece A. Turning the operating handle 511 of the pivoting control structure 50 can control the action of clamping or releasing the workpiece A, and self-locking action is achieved without the use of any locking means, when the operating handle 511 is pivoted to a desired position. Hence, the clamping device providing a convenient and stable clamping, and the overall added value is high.

Besides, rotating the pivoting member N1 can control the displacement of the movable member N2, which consequently controls the length of the retractable seat N, and then with the aid of the elastic abutting unit 52, the clamping force for clamping the workpiece A applied by the clamping member 43 can be micro-adjusted.

While we have shown and described various embodiments in accordance with the present invention, it is clear to those skilled in the art that further embodiments may be made without departing from the scope of the present invention.

What is claimed is:

1. A clamping device for an engine parts grinder, comprising:
a drive source including a drive toothed wheel sleeved onto and driven by a drive shaft, and two driven toothed wheels engaged with the drive toothed wheel;
a base including an assembling shaft portion extending in an axial direction, and an assembling hole extending in the axial direction, wherein a direction perpendicular to the axial direction is defined as a radial direction, the base is connected to the drive source;
a three-point clamping structure including a first support member, a second support member and a clamping member, wherein the first support member includes a first shaft and a first abutting wheel located at one end of the first shaft, the first shaft is pivotally inserted through the base and fixed to one of the driven toothed wheels, in such a manner that the first abutting wheel protrudes out of the base, the second support member includes a second shaft and a second abutting wheel located at one end of the second shaft, the second shaft is pivotally inserted through the base and fixed to another one of the driven toothed wheels, in such a manner that the second abutting wheel protrudes out of the base, the clamping member is mounted on a pivoting control structure pivotally mounted on the base, and is able to pivot toward or away from the first and second support members;
the pivoting control structure is mounted on the base to pivotally press a workpiece, and includes an operating member, an elastic abutting unit and a pressing unit, wherein the operating member includes an operating handle pivotally mounted on the assembling shaft portion of the base, and includes a helical groove formed in an outer peripheral surface of the operating member;
the elastic abutting unit sequentially includes a sealing cover, a spring and an abutting head, the sealing cover serves to seal one end of the assembling hole, the spring serves to press the abutting head, and the abutting head partially protrudes out of another end of the assembling hole; and
the pressing unit includes a driven shaft portion, and a cam arm and an extension arm formed at two sides of the driven shaft portion, respectively, the driven shaft portion includes a driven protrusion, the cam arm includes a cam portion, and the extension arm is pivotally connected to the clamping member, the cam portion of the pressing unit is pivotally connected to the base by a pivot extending in the radial direction, in such a manner that the cam portion abuts against the abutting head, the driven protrusion is received in the helical groove, the helical groove and the driven protrusion provide a self-locking function, so that the operating member is able to drive the driven protrusion to move, while the driven protrusion is unable to drive the operating member to move, the pressing unit is moved by the operating member to make the clamping member pivot toward the first and second support members disposed on the base to clamp the workpiece;
wherein the extension arm includes a stationary seat and a retractable seat, the stationary seat includes a through hole for insertion of the retractable seat, the clamping member is pivotally connected to one end of the retractable seat, a length of the retractable seat is adjustable, when the length of the retractable seat is increased, a clamping force of the clamping member applied to the workpiece also increases, and conversely, when the length of the retractable seat decreases, the clamping force applied to the workpiece by the clamping member also decreases.

2. The clamping device as claimed in claim 1, wherein the base includes two opposite assembling portions, and the cam portion of the pressing unit is pivotally connected between the two assembling portions of the base by the pivot.

3. The clamping device as claimed in claim 1, wherein the assembling hole includes a threaded section, and the sealing cover is screwed in the threaded section to seal the assembling hole.

4. The clamping device as claimed in claim 1, wherein the base is connected to the drive source via an adjustment structure, the base includes an insertion portion and a guide groove, the adjustment structure includes an inserting member, a slide rod and a stationary rod, the inserting member is fixed to the drive source and includes a first insertion hole and a second insertion hole, the slide rod is slidably inserted in the first insertion hole and received in the insertion portion of the base, a plurality of screws are screwed through the inserting member and the insertion portion to fix the slide rod to the inserting member and the insertion portion, the stationary rod is inserted in the second insertion hole and provided at one end thereof with an abutting portion to be abutted against the guide groove of the base, and the first and second abutting wheels are located at two sides of the guide groove.

5. The clamping device as claimed in claim 1, wherein the first and second abutting wheels each include an avoiding groove along a peripheral surface thereof, and the clamping member has a thickness smaller than a width of the avoiding groove of the first and second abutting wheels.

6. The clamping device as claimed in claim 1, wherein the stationary seat includes a seat body and a seat cover which covers one end of the seat body, the retractable seat includes a pivoting member and a movable member, a direction in which the retractable seat extends is defined as a retracting direction, the pivoting member is sequentially provided in the retracting direction with a pivoting section and a threaded section, the threaded section is provided on an outer surface thereof with a thread, and the pivoting section protrudes out of the stationary seat and is to be rotated by a user;
the clamping member is pivotally connected to one end of the movable member which is inserted in the through hole, and another end of the movable member is formed with a threaded hole in which the threaded section is to be screwed, so that, when the user rotates the pivoting member with respect to the stationary seat, the movable member will move along the retracting direction, so as to adjust the length of the retractable seat.

7. The clamping device as claimed in claim 6, wherein the pivoting member further includes a restricting section between the pivoting section and the threaded section, the restricting section has a diameter larger than a diameter of the pivoting section and a diameter of the threaded section, the restricting section and the threaded section are inserted in the through hole, in such a manner that the restricting section is abutted against the seat cover to act as a travel limiter.

8. The clamping device as claimed in claim 6, wherein a rotating handle is sleeved onto the pivoting section and has one end abutted against the seat cover.

9. The clamping device as claimed in claim 6, wherein a movable member includes an outer surface, and an adjustment groove formed in the outer surface and extending in the retracting direction, the seat body is provided with a penetrating hole, and a bolt is inserted in the penetrating hole and pressed against the adjustment groove.

10. The clamping device as claimed in claim 7, wherein a movable member includes an outer surface, and an adjustment groove formed in the outer surface and extending in the retracting direction, the seat body is provided with a penetrating hole, and a bolt is inserted in the penetrating hole and pressed against the adjustment groove.

11. The clamping device as claimed in claim 8, wherein a movable member includes an outer surface, and an adjustment groove formed in the outer surface and extending in the retracting direction, the seat body is provided with a penetrating hole, and a bolt is inserted in the penetrating hole and pressed against the adjustment groove.

12. The clamping device as claimed in claim 6, wherein the extension arm is provided with an assistant seat which is to be pivotally connected to the stationary seat, the assistant seat is parallel to and driven to move together with the retractable seat along the retracting direction, and an assistant abutting member is provided at one end of the assistant seat to press against the workpiece.

13. The clamping device as claimed in claim 7, wherein the extension arm is provided with an assistant seat which is to be pivotally connected to the stationary seat, the assistant seat is parallel to and driven to move together with the retractable seat along the retracting direction, and an assistant abutting member is provided at one end of the assistant seat to press against the workpiece.

14. The clamping device as claimed in claim 8, wherein the extension arm is provided with an assistant seat which is to be pivotally connected to the stationary seat, the assistant seat is parallel to and driven to move together with the retractable seat along the retracting direction, and an assistant abutting member is provided at one end of the assistant seat to press against the workpiece.
